(19) United States
(12) Patent Application Publication
(10) Pub. No.: US 2015/0060736 A1
(43) Pub. Date: Mar. 5, 2015

(54) Systems, Devices, and/or Methods for Preparation of Graphene and Graphene Hybrid Composite Via the Pyrolysis of Milled Solid Carbon Sources

(71) Applicants: Nguyen C. Khe, Ho Chi Minh City (VN); Hieu Dinh, San Jose, CA (US)

(72) Inventors: Nguyen C. Khe, Ho Chi Minh City (VN); Hieu Dinh, San Jose, CA (US)

(21) Appl. No.: 13/261,984

(22) PCT Filed: Sep. 29, 2012
(86) PCT No.: PCT/US2012/058161

§ 371 Date: May 7, 2014

Related U.S. Application Data
(63) Continuation-in-part of application No. 13/290,108, filed on Nov. 7, 2011.

(51) Int. Cl. H01B 1/04

(52) U.S. Cl. CPC H01B 1/04
USPC 252/503; 252/502; 252/511; 252/510

(57) ABSTRACT

Certain exemplary embodiments can provide a system comprising a hybrid composite. The hybrid composite can comprise tubular carbon and graphene produced via pyrolysis of a milled solid carbon source under an unoxidizing environment. When analyzed via X-ray diffraction, the hybrid composite can generate peaks at two theta values of approximately 26.5 degrees, approximately 42.5 degrees, and/or approximately 54.5 degrees.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a graph 1000 of resistivity values for pyrolysis products of exemplary embodiments;

FIG. 2 is a graph 2000 of X-ray diffraction (“XRD”) results for an exemplary pyrolysis product according to an exemplary embodiment;

FIG. 3 is a graph 3000 of X-ray diffraction (“XRD”) results for an exemplary pyrolysis product according to an exemplary embodiment;

FIG. 4 is a graph 4000 of X-ray diffraction (“XRD”) results for an exemplary pyrolysis product according to an exemplary embodiment;

FIG. 5 is a graph 5000 of X-ray diffraction (“XRD”) results for an exemplary pyrolysis product according to an exemplary embodiment;

FIG. 6 is a graph 6000 of X-ray diffraction (“XRD”) results for an exemplary pyrolysis product according to an exemplary embodiment;

FIG. 7 is a graph 7000 of X-ray diffraction (“XRD”) results for an exemplary pyrolysis product according to an exemplary embodiment;

FIG. 8 is a FE-SEM image 8000 of an exemplary pyrolysis product according to an exemplary embodiment;

FIG. 9 is a FE-SEM image 9000 of an exemplary pyrolysis product according to an exemplary embodiment;

FIG. 10 is a FE-SEM image 10000 of an exemplary pyrolysis product according to an exemplary embodiment;

FIG. 11 is a FE-SEM image 11000 of an exemplary pyrolysis product according to an exemplary embodiment;

FIG. 12 is a TEM image 12000 of an exemplary pyrolysis product according to an exemplary embodiment;

FIG. 13 is a TEM image 13000 of an exemplary pyrolysis product according to an exemplary embodiment;

FIG. 14 is a graph 14000 of resistivity values for pyrolysis products of exemplary embodiments produced with different catalysts;

FIG. 15 is a graph 15000 of power values as a function of electrical current for systems using exemplary embodiments;

FIG. 16 is a graph 16000 of voltage values as a function of electrical current for systems using exemplary embodiments; and

FIG. 17 is a flowchart of an exemplary embodiment of a method 17000.

### DETAILED DESCRIPTION

This application claims priority to pending U.S. patent application Ser. No. 13/290,108 (Attorney Docket No. 1200-003), filed 6 Nov. 2011.

Certain exemplary embodiments can provide a system comprising a hybrid composite. The hybrid composite can comprise tubular carbon and graphene produced via pyrolysis of a milled solid carbon source under an unoxidizing environment. When analyzed via X-ray diffraction, the hybrid composite can generate peaks at two theta values of approximately 26.5 degrees, approximately 42.5 degrees, and/or approximately 54.5 degrees.

A hybrid of graphene flakes and tubular shape nano carbon can be produced from the pyrolysis of a salt milled solid carbon source under unoxidizing environment using a specific Fe relative catalyst. The hybrid is characterized by X-Ray diffraction patterns (XRD) with diffraction peaks at two theta values of approximately 26.5 degrees, approximately 42.5 degrees, and approximately 54.5 degrees. The hybrid composite exhibits relatively high electrical conductivity and enhanced compatibility with various kinds of materials over tubular shape nano carbon products as well as relatively pure graphene nano platelets. The hybrid composite can be effective for electron producing catalysts, electro conductive applications such as conductive painting and lacquers, electromagnetic shielding, conductive inks, transparent conductors, electro conductive mechanical processing such as bipolar plates for hydrogen fuel cells, biosensors, glucose meters, and/or alcohol detectors, etc.

Carbon can have four unique crystalline structures, including diamond, graphite, fullerene, and carbon nano-tubes. Graphene is an allotrope of carbon, whose structure comprises substantially one-atom-thick planar sheets of sp-bonded carbon atoms that are packed in a honeycomb crystal lattice. Graphene can be visualized as an atomic-scale sheet made of carbon atoms and their bonds. The crystalline or “flake” form of graphite consists of many graphene sheets stacked together.

The phrase “carbon nano-tube” (“CNT”) refers to a tubular structure, which can be grown with a single wall or multi-walls. A CNT can be conceptually visualized as rolling up a graphene sheet or several graphene sheets to form a concentric hollow structure. A graphene sheet comprises carbon atoms occupying a two-dimensional hexagonal lattice. By dispersing oxidized and chemically processed graphite in water, and using paper-making techniques, substantially monolayer flakes can form a single sheet and bond relatively powerfully. Such sheets, which can be called graphene oxide paper, can have a measured tensile modulus of approximately 32 Gigapascals (“GPa”). Chemical properties of graphite oxide can be related to functional groups attached to graphene sheets. The functional groups can change the pathway of polymerization and similar chemical processes. Graphene oxide flakes in polymers can have enhanced photo-conducting properties compared to polymers lacking such flakes.

Graphene nano platelets can comprise a stack of multi-layer graphene sheets. Graphite has a layered, substantially planar structure. In each layer, the carbon atoms are arranged in a hexagonal lattice with separation of approximately 0.142 nanometers (“nm”), and the distance between planes is approximately 0.335 nm. Two forms of graphite, alpha (hexagonal) and beta (rhombohedral), have very similar physical properties (except that the graphene layers stack slightly differently). The hexagonal graphite can be either flat or buckled. The alpha form can be converted to the beta form through mechanical treatment and the beta form can revert to the alpha form when it is heated above approximately 1300° Celsius. The layering contributes to its relatively low density.

CNTs can have a diameter that ranges from on the order of a few nanometers to a few hundred nanometers. CNTs can function as either a conductor or a semiconductor, depending on the rolled shape and the diameter of the tubes. A longitudinal, hollow structure imparts unique mechanical, electrical, and chemical properties to CNTs. CNTs can be used in field emission devices, hydrogen fuel storage, rechargeable battery electrodes, and/or composite reinforcements, etc. However, CNTs can be relatively expensive due to the low yield and low production and purification rates associated with certain CNT preparation processes. High material costs might hinder widespread application of CNTs. Certain exemplary embodiments provide processes for producing individual nano-scaled graphite planes (individual graphene sheets) and stacks of multiple nano-scaled graphene sheets, which can be collectively called nano-scaled graphene plates (NGPs) or nano graphene platelets. NGPs may be visualized by making a longitudinal scission on the single-wall or multi-wall of a nano-tube along its tube axis direction and then flattening up the resulting sheet or plate. Certain exemplary nano materials can be substitutes for carbon nano-tubes or other types of nano-rods for various scientific and engineering applications. Certain exemplary embodiments provide for an indirect synthesis approach for preparing NGPs and related materials. Certain exemplary processes comprise (1) providing a graphite powder containing fine graphite particles (particulates, short fiber segments, carbon whisker, graphitic nano-fibers, and/or combinations thereof) preferably with at least one dimension smaller than approximately 1 micrometer); (2) exfoliating the graphite crystallites in these particles in such a manner that at least two graphene planes are either partially or fully separated from each other, and (3) mechanical attrition (e.g., ball milling) of the exfoliated particles to become nano-scaled to obtain NGPs. The starting powder type and size, exfoliation conditions (e.g., intercalation chemical type and concentration, temperature cycles, and the mechanical attrition conditions (e.g., ball milling time and intensity) can be varied to generate, by design, various NGP materials with a wide range of graphene plate thickness, width and length values. Ball milling can be an effective process for mass-producing ultra-fine powder particles. The processing ease and the wide property ranges that can be achieved with NGP materials make them candidates for many important industrial applications. The electronic, thermal, and mechanical properties of NGP materials can be comparable to those of carbon nano-tubes.

In certain exemplary embodiments, graphene sheets can be made via chemical vapor deposition of methane to grow graphene on thin nickel films. Certain exemplary embodiments provide a process of making graphene nanoribbons in which graphene is twisted within nanotubes. In certain exemplary embodiments, these materials can be characterized by one or more of poor dispersion, not having enough electro conductivity, limited compatibility with other materials for development of composites for new applications, and/or high cost as materials manufacturing requires plasma CVD reactor of gas phase materials.

In certain exemplary embodiments, a type of nano carbon hybrid comprised of tubular shape nano carbon and graphene can be prepared by the pyrolysis of solid carbon source(s) using specific catalyst comprising iron relatives. According to the effect of the iron related catalyst, the amount of the catalyst or MS/CS ratio; wherein MS means metal source, CS means solid carbon source; can provide many products having different properties. In certain exemplary MS/CS ratios, the hybrid exhibits relatively high electro conductivity, relatively good dispersion, and/or relatively good compatibility with other materials. Certain exemplary embodiments can utilize an iron related catalyst to convert a milled solid carbon source into graphene or graphene hybrid with tubular nano carbon, which gives rise to relatively good conductivity at the certain range of MS/CS ratios. MS/CS values less than approximately 0.10 can give rise to the tubular shape nano carbon. MS/CS values greater than approximately 0.3 and give rise to the graphene related products.

In order to obtain the above described properties, the tubular shape nano carbon products (tube, wire, rod) and graphene related products can be prepared via two steps:
the first step is grinding the solid carbon sources to a relatively fine size via a milling process, such as via salt milling; salt milling is a grinding process adapted to turn solid carbon sources into finer particle to absorb catalyst molecules before going to the pyrolysis; and
the second step is the pyrolysis of the solid carbon sources in an unoxidizing environment.

Certain exemplary embodiments provide relatively good electro conductivity. The solid carbon sources can be selected from a large variety of solid carbon sources already exist in nature including tree woods, beans, cotton, agricultural products such as paddy husks and/or coconut shells, etc.

The above cited solid carbon sources can be used alone or can be used together with certain kind of chemicals having functionality of forming tube. These chemicals art so called as tube control agent (TCA). The TCA molecules usually contain carbonitrile —CN functional groups and examples of TCA comprise tree lignin, phthalonitrile, and/or other derivatives, etc.

For salt milling, any salts can be used including NaCl (table salt), NaBr, NaI, NaF, Na2CO3, organic salts, and/or inorganic salts, etc. The salt milling process can be done with any devices having grinding, blending, and/or mixing mechanisms. The milling process can be performed with different milling media instead of and/or in addition to salt, such as glass beads, plastic beads, ceramic beads, metallic balls, and/or metallic beads, etc. Salt removal from salt milled solid carbon sources can be done by washing the milled solid carbon with water. Tap water, deionized water, sea water, hot or cold water, and/or any solvents capable of dissolving the salts can be effectively used as agents for washing.

The following is an example (hereinafter referenced as “Example 1”) of an exemplary embodiment:
Step 1: Rough grinding—a branch of red wood was ground with wood grinder to achieve wood chips having average particle size of a few millimeters to a few centimeters.
Step 2: Fine grinding—the wood chip were ground again with fine wood grinder to achieve particles having an average particle size in the range of approximately 500 microns.
Step 3: Salt milling—the finely ground particles of step 2 were mixed with table salt in a glass jar and milled by a rotary miller. The milled particles were poured into a beaker containing tap water and the mixture was stirred with magnetic stirrer for approximately one hour, and then filtered to collect the salt milled wood. The process was repeated until the salt was substantially removed. The salt milled product was dried in an oven.
Step 4: Mixing with catalyst—approximately 10 grams of NiCl₂.6H₂O (“Ni salt”) MS was substantially dissolved in a beaker containing approximately 100 grams of deionized water and the amount of salt milled solid CS of step 3 was calculated such that the MS/CS by weight was approximately 0.05. The salt milled product was slowly adding into the solution of Ni salt and stirred at a temperature of approximately 100 degrees Celsius to evaporate the water.
Step 5: Making nano carbon and graphene related—The nano carbon precursor prepared in step 4 was fed into a quartz tube filled with vacuum and baked at approximately 900 degrees Celsius for approximately one hour. Then the heat source was shut down and cooled off to room temperature. The black product was collected and washed with HC1 at a concentration of approximately 6 Molar for approximately one hour at approximately 70 degrees Celsius to remove metal catalyst then dried in an oven at approximately 80 degrees Celsius for approximately three hours to achieve a nano carbon product.

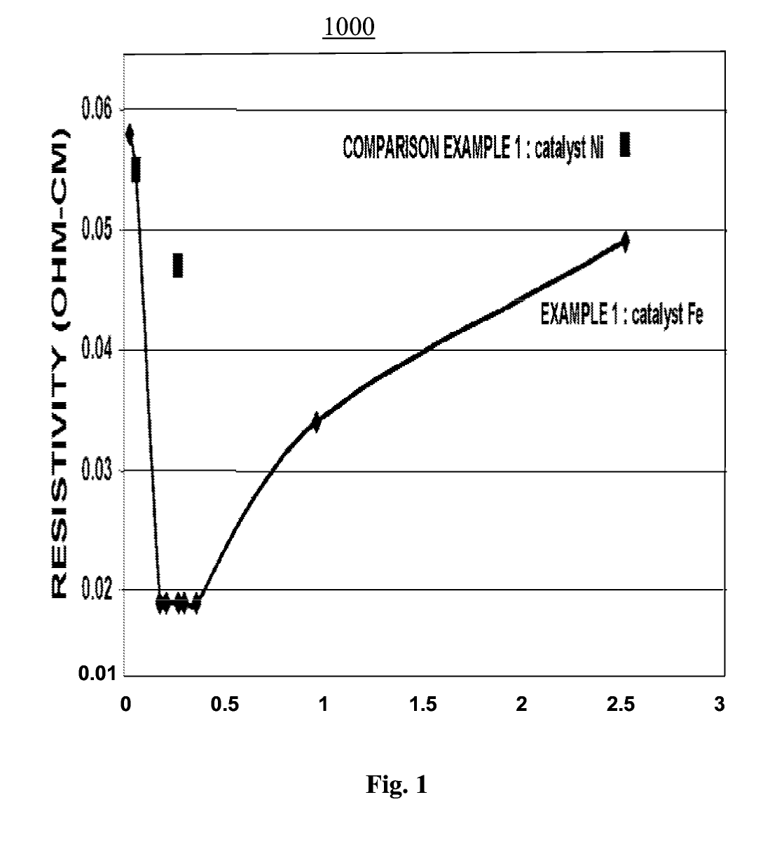

FIG. 1 is a graph 1000 of resistivity values for pyrolysis products of exemplary embodiments. Bulk electrical resistivity values of pyrolysis products produced in accordance with Example 1, at different MS/CS ratio for iron (Fe) catalyst and non iron catalyst (Ni, comparison example), were measured. FIG. 1 illustrates the effect of (MS/CS) ratio on the bulk resistivity (ohm-cm) of the pyrolysis products prepared by two different kinds of catalyst; the iron, as prepared in accordance Example 1 and a nickel (“Ni”) catalyst for comparison.

From the result described in FIG. 1, one can see that both catalysts exhibit the maximum electroconductivity in the vicinity of (MS/CS) ratio between approximately 0.10-0.20. The electrical resistivity of the pyrolysis products due to Fe catalyst is much lower than that of non-ferric type (for example Ni) in the value range between approximately 0.013-0.019 (ohm-cm). For a reference, the bulk electrical resistivity of a single walled nano tube, commercially available from Cheaptubes LLC, is approximately 0.079 ohm-cm, the bulk electrical resistivity of the graphene nano platelet, commercially available from Cheaptubes LLC, is approximately 0.055 ohm-cm.

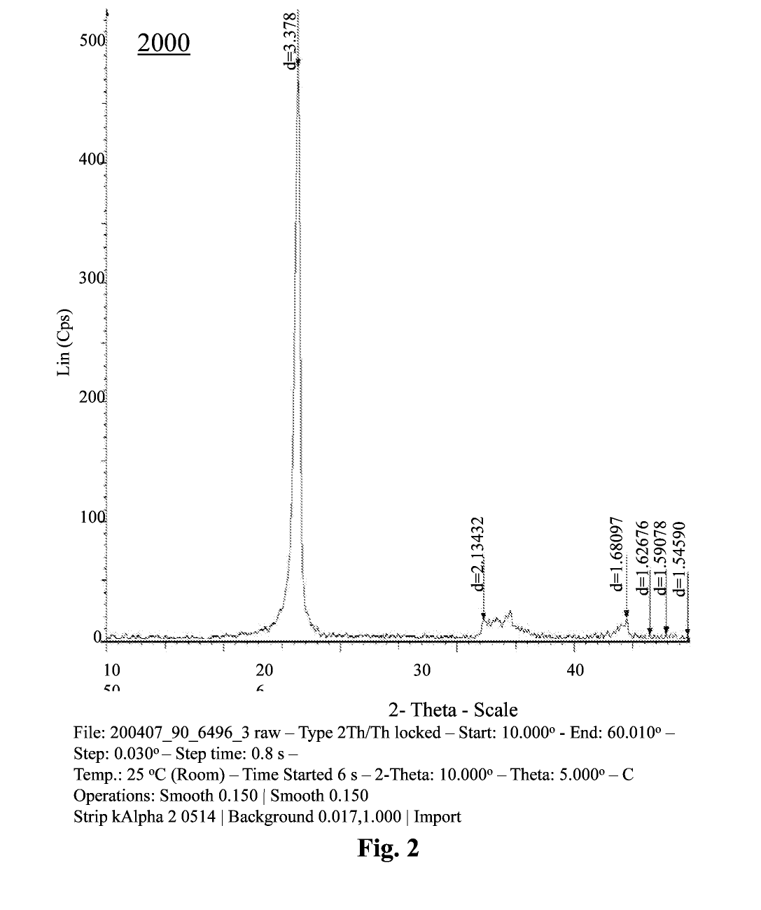

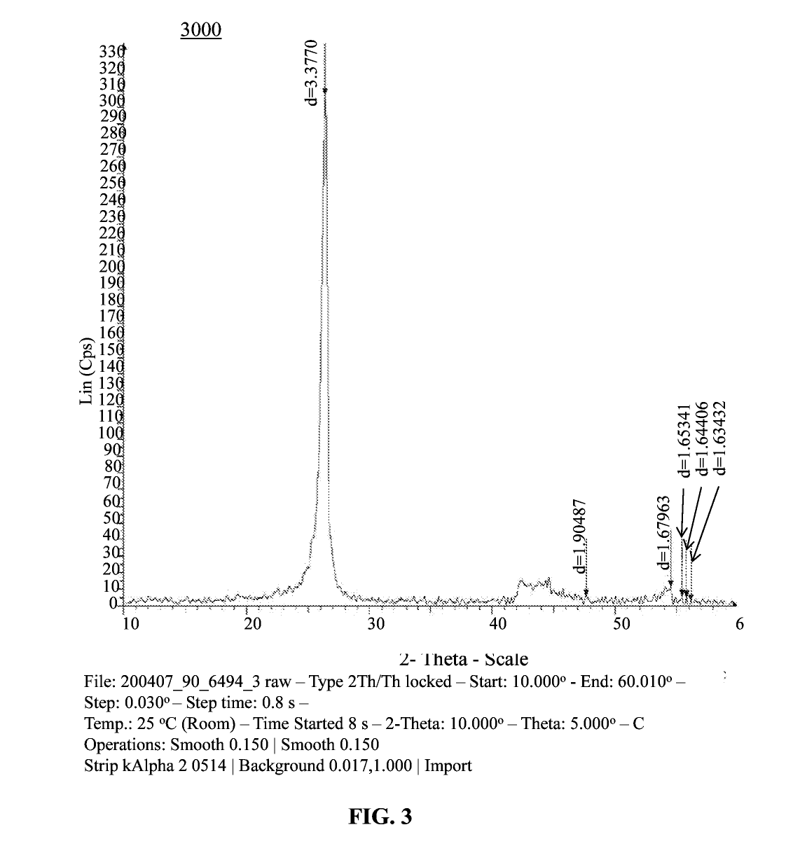

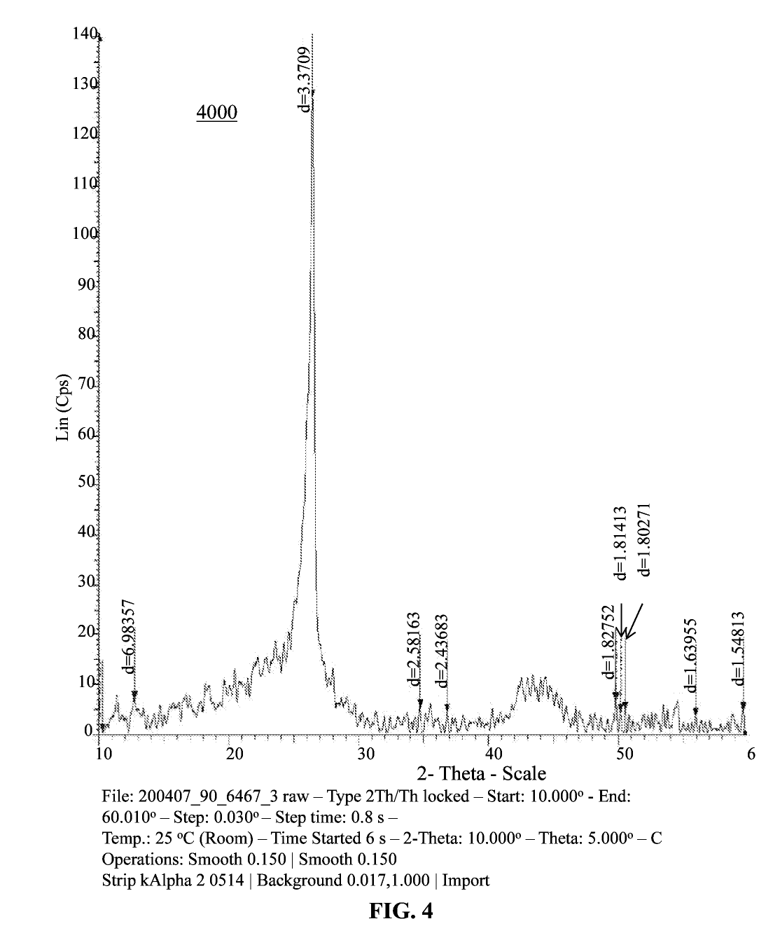

FIG. 2 is a graph 2000 of X-ray diffraction (“XRD”) results for an exemplary pyrolysis product according to an exemplary embodiment. The pyrolysis product that was analyzed in FIG. 2 was prepared from a Fe catalyst with an MS/CS ratio of approximately 0.24. FIG. 3 is a graph 3000 of X-ray diffraction (“XRD”) results for an exemplary pyrolysis product according to an exemplary embodiment. The pyrolysis product that was analyzed in FIG. 3 was prepared from salt milled solid carbon sources using a Fe catalyst with an MS/CS ratio of approximately 0.18. FIG. 4 is a graph 4000 of X-ray diffraction (“XRD”) results for an exemplary pyrolysis product according to an exemplary embodiment. The pyrolysis product that was analyzed in FIG. 4 was prepared from salt milled solid carbon sources using a Fe catalyst with an MS/CS ratio of approximately 0.48.

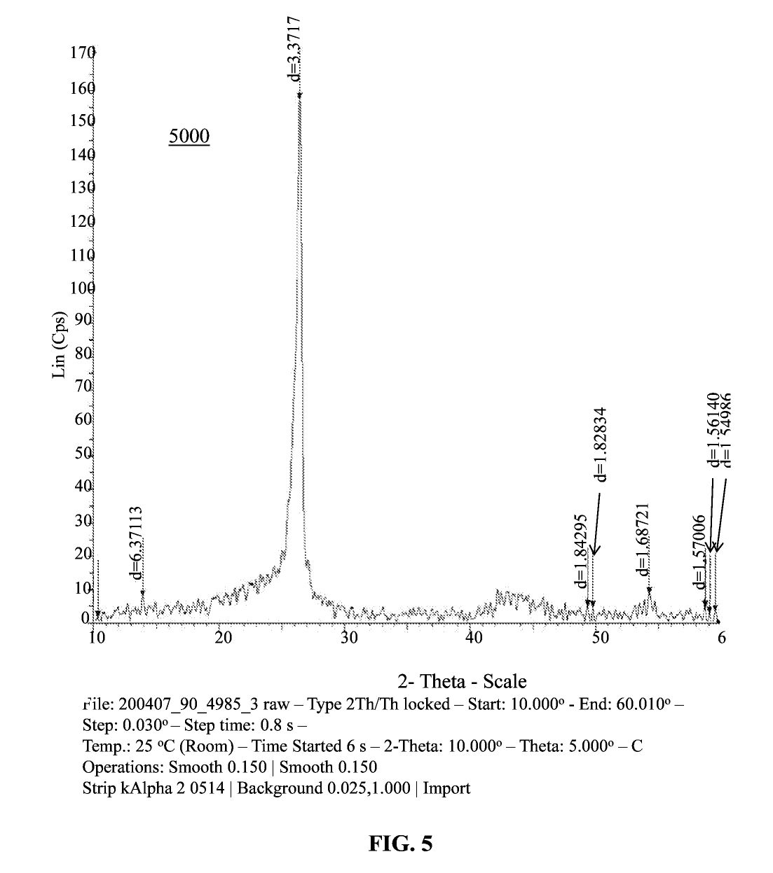

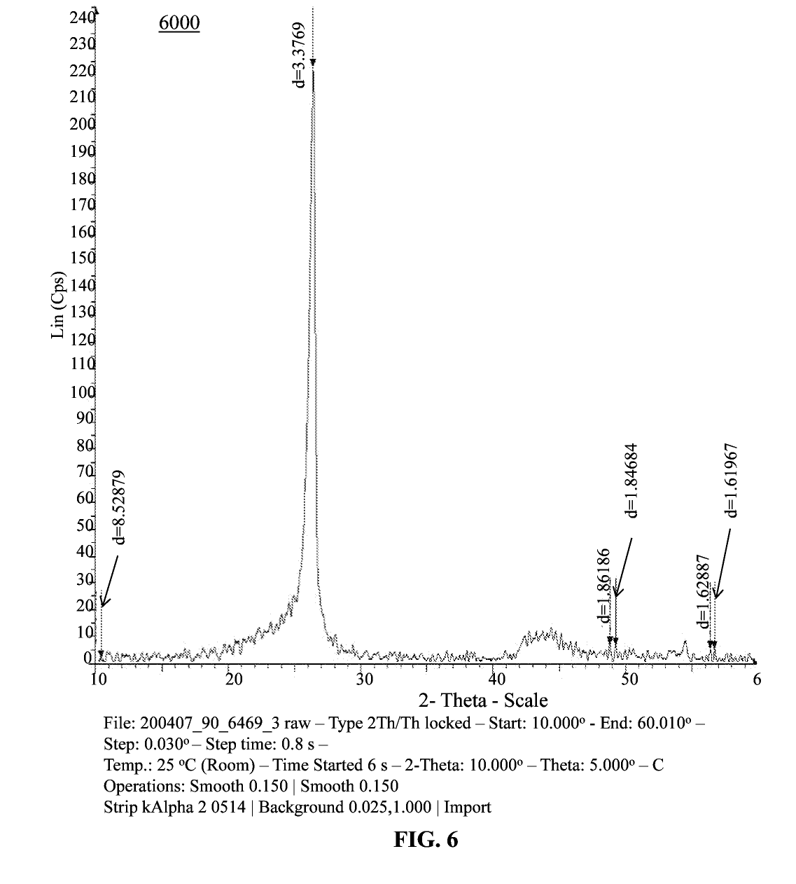

FIG. 5 is a graph 5000 of X-ray diffraction (“XRD”) results for an exemplary pyrolysis product according to an exemplary embodiment. The pyrolysis product that was analyzed in FIG. 5 was prepared from salt milled solid carbon sources using a Fe catalyst with an MS/CS ratio of approximately 0.12. FIG. 6 is a graph 6000 of X-ray diffraction (“XRD”) results for an exemplary pyrolysis product according to an exemplary embodiment. The pyrolysis product that was analyzed in FIG. 6 was prepared from salt milled solid carbon sources using a Fe catalyst with an MS/CS ratio of approximately 0.96.

FIG. 2, FIG. 3, FIG. 4, FIG. 5, and FIG. 6 exhibit X-ray diffraction (“XRD”) results of various pyrolysis products prepared with Fe catalyst at different levels of catalyst use. Each of these samples exhibited XRD results with diffraction peaks appeared at two theta of approximately 26.5 degrees, approximately 43 degrees, and approximately 54 degrees.

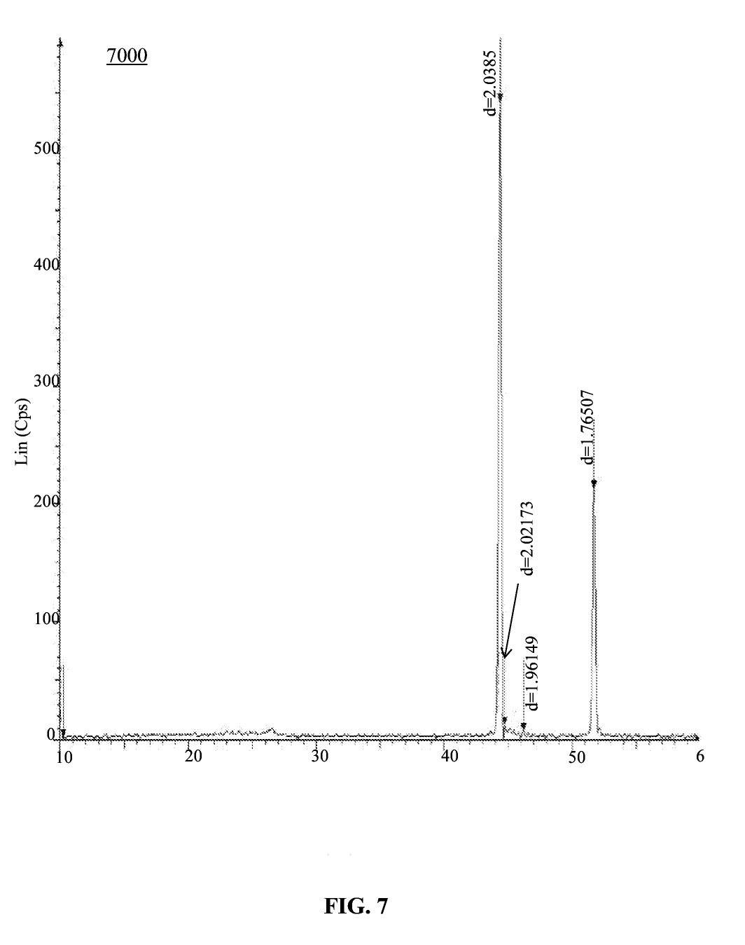

FIG. 7 is a graph 7000 of X-ray diffraction (“XRD”) results for an exemplary pyrolysis product according to an exemplary embodiment. The pyrolysis product that was analyzed in FIG. 7 was prepared from salt milled solid carbon sources using a Ni catalyst with an MS/CS ratio of approximately 2.56. Diffraction peaks appeared at two theta values of approximately 44.5 degrees and approximately 51.6 degrees. Certain exemplary pyrolysis products were imaged using Field Emission Scanning Electron Microscopy (“FE-SEM”).

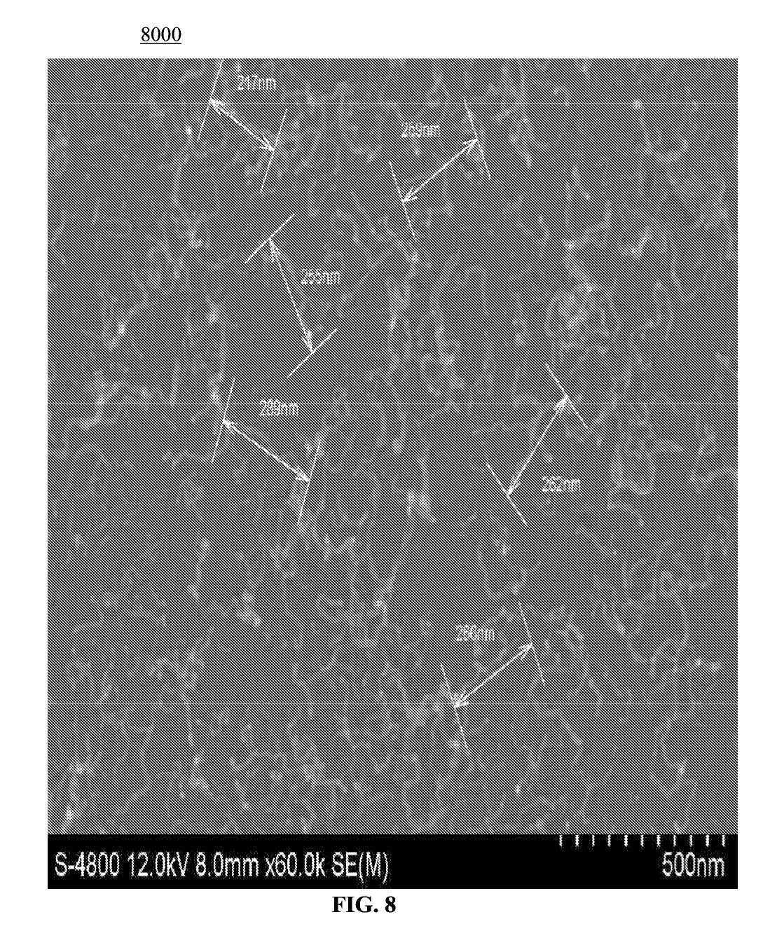

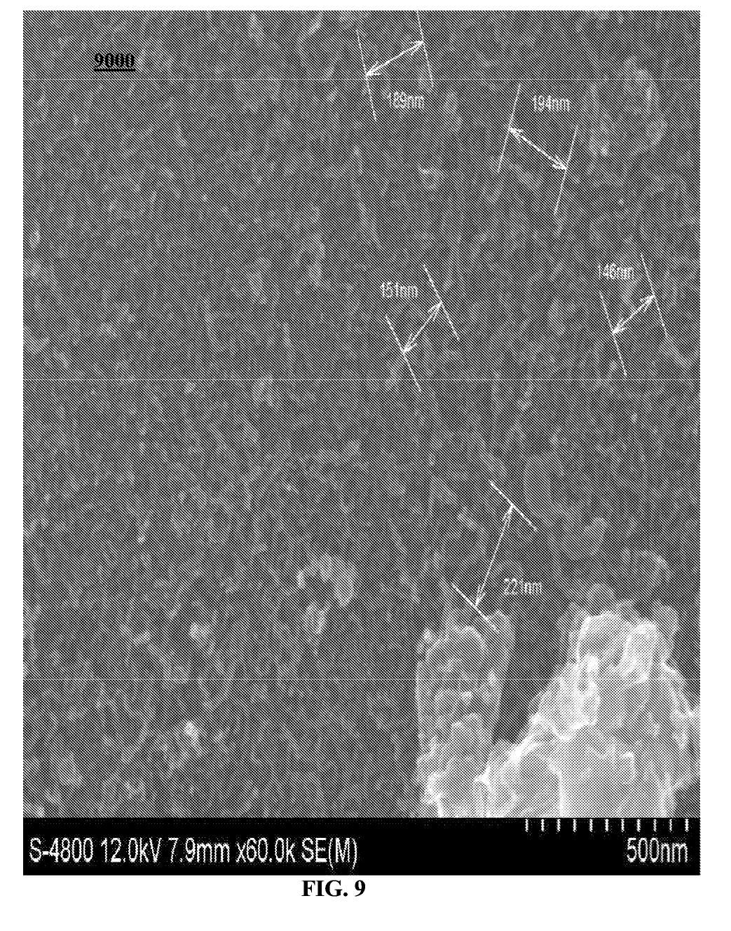

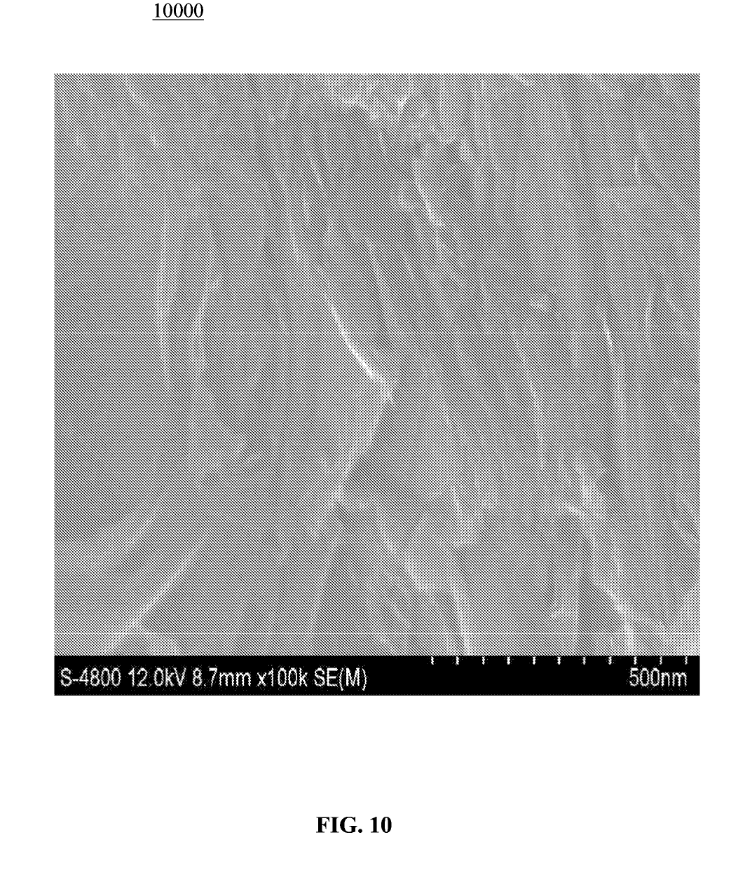

FIG. 8 is a FE-SEM image 8000 of an exemplary pyrolysis product according to an exemplary embodiment. The pyrolysis products in FIG. 8 were produced with a Fe catalyst with an MS/CS ratio of approximately 0.06. One can see the tubular shape nano carbon. FIG. 9 is a FE-SEM image 9000 of an exemplary pyrolysis product according to an exemplary embodiment. The pyrolysis products in FIG. 9 were produced with a Fe catalyst with an MS/CS ratio of approximately 0.03. One can see more tubular shape nano carbon. FIG. 10 is a FE-SEM image 10000 of an exemplary pyrolysis product according to an exemplary embodiment. The pyrolysis products in FIG. 10 were produced with a Fe catalyst with an MS/CS ratio of approximately 0.16. One can see that substantially no tubular shape nano carbon is present, but can see flakes instead.

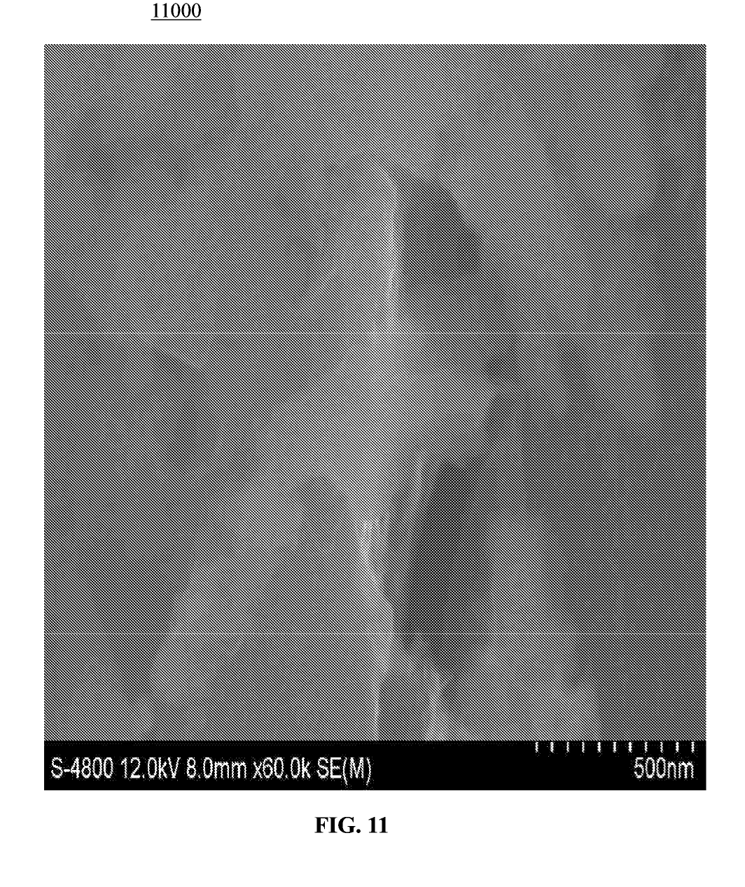

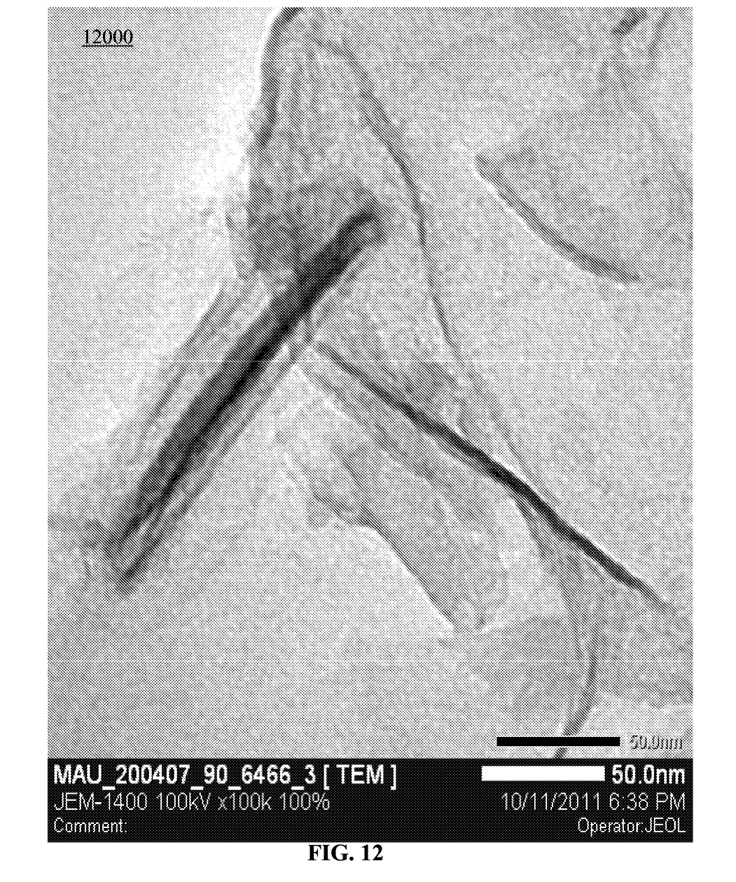

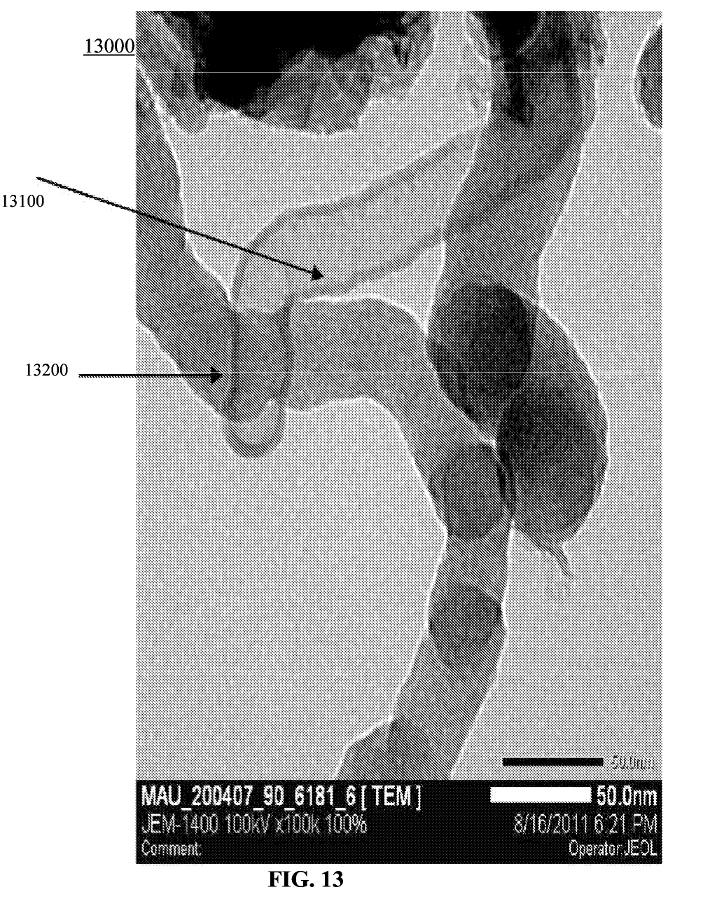

FIG. 11 is a FE-SEM image 11000 of an exemplary pyrolysis product according to an exemplary embodiment. The pyrolysis products in FIG. 11 were produced with a Fe catalyst with an MS/CS ratio of approximately 2.5. One can see substantially only flake shaped nano carbon. Certain substances were examined via Transmission Electron Microscopy (“TEM”). FIG. 12 is a TEM image 12000 of an exemplary pyrolysis product according to an exemplary embodiment. The pyrolysis products in FIG. 12 were produced with a Fe catalyst with an MS/CS ratio of approximately 0.48. One can see a tubular component and a flake component co-existing. FIG. 13 is a TEM image 13000 of an exemplary pyrolysis product according to an exemplary embodiment. The pyrolysis products in FIG. 13 were produced with a Fe catalyst with an MS/CS ratio of approximately 0.05. The tubular nano carbon shows carbon nano tube 13100, which appears to be substantially hollow; and carbon nano wire and carbon nano rod 13200, which appears to be substantially solid.

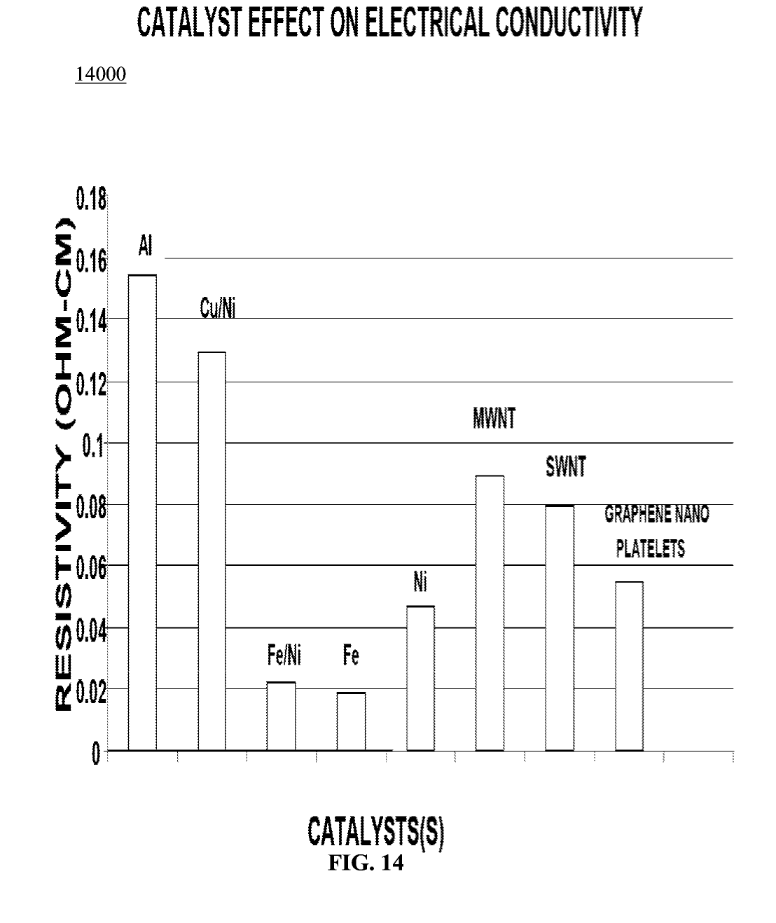

FIG. 14 is a graph 14000 of resistivity values for pyrolysis products of exemplary embodiments produced with different catalysts. FIG. 14 exhibits a comparison effect of various kinds of metal catalyst in the pyrolysis reaction on the electrical resistivity of pyrolysis products. The MS/CS ratio of approximately 0.24 was set for all of experiments. The electrical resistivity of commercially available nano carbon products; single walled nanotubes, multiple walled nanotubes, and graphene nano platelets are shown for reference. The graphene hybrid shows the lowest bulk resistivity with Fe catalyst.

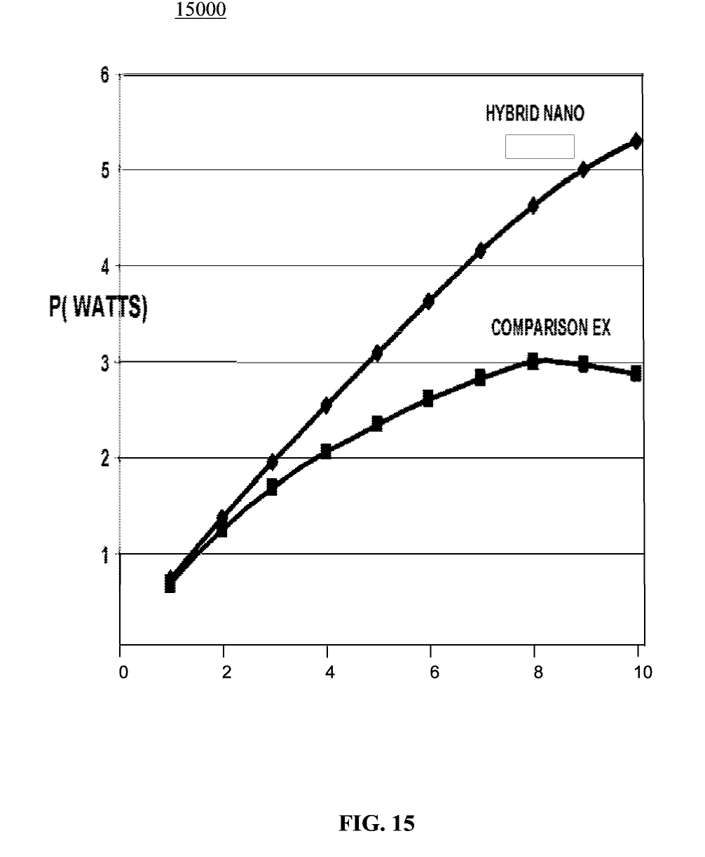

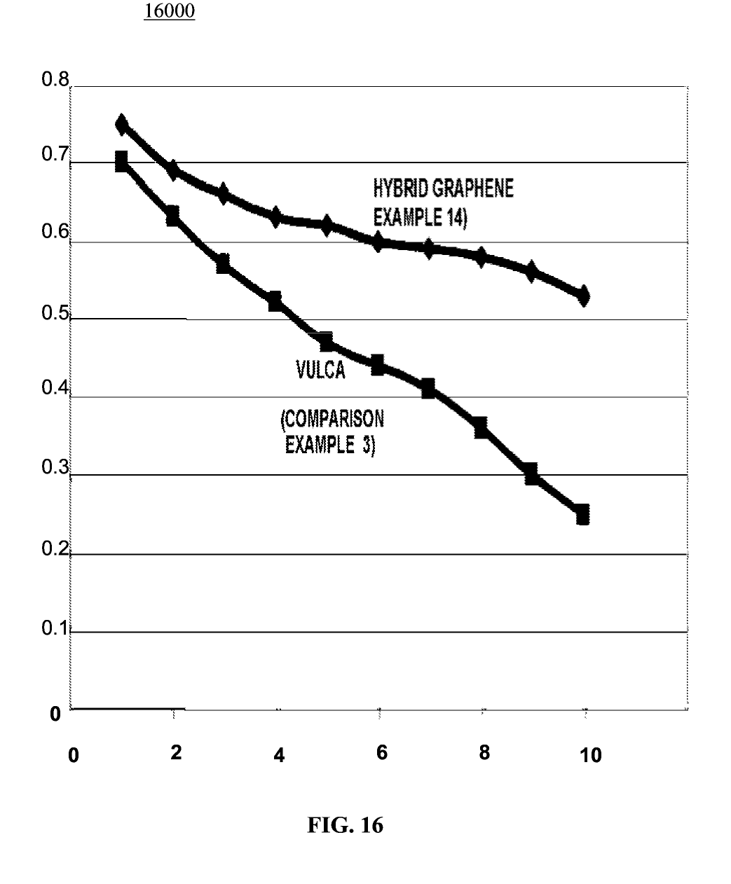

In a Proton Exchange Membrane assembly, a proton transporter, Nafion® film 211 (Nafion is a registered trademark of E.I. DuPont De Nemours and Company and Nafion products can be obtained therefrom), was sandwiched between two different kinds of H₂ reducing catalyst over brushed onto gas diffusion materials (Toray Carbon Paper). The active area of the gas diffusion materials was approximately 52.29 cm². In this case, the cathodic catalyst is composed of Platinum/hybrid graphene in a ratio of approximately 60/40 (the hybrid graphene prepared as in Example 1) and an anodic catalyst composed of Platinum/Ruthenium/hybrid graphene in relative ratios of approximately 60/20/20 (the hybrid graphene prepared as in Example 1). The system was exposed to an H₂ source at a rate of approximately 100 milliliters/minute on the anode site and O₂ source at a flow rate of approximately 50 milliliters/minute on the cathode site using a Fuelcell Test Station made by Electrochem, Inc. This experiment was repeated except that hybrid graphene is replaced with Vulcan XR72 from Cabot Corporation. FIG. 15 is a graph 15000 of power values as a function of electrical current for the systems used in these experiments. FIG. 16 is a graph 16000 of voltage values as a function of electrical current for the systems used in these experiments.

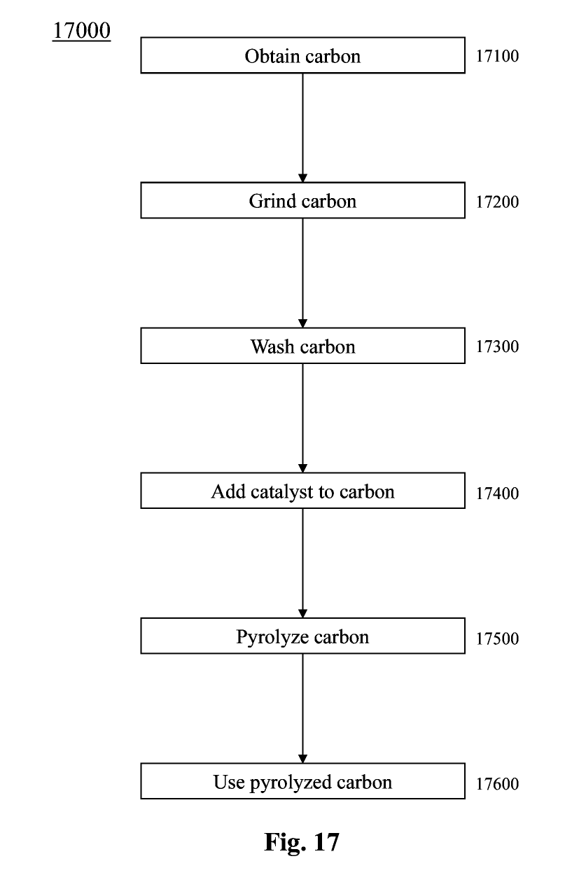

FIG. 17 is a flowchart of an exemplary embodiment of a method 17000. At activity 17100, carbon can be obtained from a solid carbon source. For example, the solid carbon source can be obtained from one or more of tree woods, beans, cotton, paddy husks, and/or coconut shells, etc. At activity 17200, the solid carbon source can be ground such as via a milling process. In certain exemplary embodiments, the solid carbon source can be salt milled. At activity 17300, the solid carbon source can be washed with a solvent. Via the solvent, soluble substances, such as salt used in grinding the solid carbon source, can be removed from the solid carbon source.

In certain exemplary embodiments, a catalyst comprising iron can be produced. The catalyst can be arranged in a molecule that will not fully adsorb carbon free radicals. Full adsorption can occur when the catalyst molecules are separated from each other due to small MS/CS ratio less than approximately 0.06. Partial adsorption can occur when the MS/CS ratio is greater than approximately 0.1. The greater MS/CS ratio, the tighter the catalyst molecule packing becomes and can be thought of as forming into a catalyst wall where the free radicals of carbon adsorb at substantially one site, and thus grow into a carbon sheet instead of carbon tube. Many approaches of making graphene using graphite oxide as oxide can work as a divider to separate out the carbon sheet. Certain exemplary embodiments use a specific catalyst such as Fe relatives to enhance the adsorption, and use the amount of catalyst (MS/CS greater than approximately 0.10) to form a divider. Salt-milled carbon sources can absorb more catalyst than materials that are not salt milled.

At activity 17400, a catalyst can be added to the solid carbon source. For example, a specific catalyst comprised of at least one component containing iron relatives or a combination of iron relatives with more than one metal component can be used.

At activity 17500, the solid carbon source can be pyrolyzed to form a hybrid composite. In certain exemplary embodiments, the solid carbon source can be pyrolyzed in an oven, via plasma chemical vapor deposition, and/or via thermal chemical vapor deposition, etc. The catalyst can be adapted to, when present with a milled solid carbon source in pyrolysis in an unoxidizing environment, produce a hybrid composite comprising tubular carbon and graphene. In certain exemplary embodiments, the hybrid composite can comprise tubular carbon and a graphene flake. In certain exemplary embodiments, the tubular carbon can be a carbon nanotube, a carbon nanorod, a carbon nanofiber, and/or a carbon nanowire. In certain exemplary embodiments, the tubular carbon can be between approximately 0.01% and approximately 99% of the hybrid composite. In certain exemplary embodiments, the hybrid composite can be produced via pyrolysis of a milled solid carbon source under an unoxidizing environment. When analyzed via X-ray diffraction, the hybrid composite can generate peaks at two theta values of approximately 26.5 degrees, approximately 42.5 degrees, and approximately 54.5 degrees.

In certain exemplary embodiments, the graphene flake, when analyzed via X-ray diffraction, generates peaks at two theta values of approximately 26.5 degrees and approximately 54.5 degrees. In certain exemplary embodiments, the tubular carbon, when analyzed via X-ray diffraction, generates peaks at two theta values of approximately 44.5 degrees and approximately 51.6 degrees.

At activity 17600, the pyrolyzed carbon can be used in any of a variety of applications. For example, a system can be produced that comprises the hybrid composite. The hybrid composite can comprise tubular carbon and a graphene flake. The hybrid composite can be present in the system in at least one of: conductive paint, conductive lacquer, electromagnetic shielding, conductive ink adapted for use in printed electronics, a conductor adapted for use in a light emitting diode, a conductor adapted for use in a solar cell, an electrical conductor adapted for use in a battery electrode, an electrical conductor, a bipolar plate adapted for use in a fuel cell, an electrocatalyst adapted for use in a fuel cell, a charge transport element or a charge generation element adapted for use in a solar cell, a photoconductor, a transistor, a biosensor, a glucose meter, and/or an alcohol detector, etc.

In certain exemplary embodiments, the hybrid composite can be blended with a solvent, a metal, a ceramic, a plastic, an oxide, a nitride, and/or a material comprising carbon, etc.

Certain exemplary embodiments provide a system comprising a device comprising a hybrid composite. The hybrid composite can be present in at least one of conductive paint, conductive lacquer, electromagnetic shielding, conductive ink adapted for use in printed electronics, a conductor and/or transparent conductor adapted for use in an LED, a conductor and/or transparent conductor adapted for use in a solar cell, an electrical conductor adapted for use in a battery electrode, an electrical conductor, a bipolar plate adapted for use in a fuel cell, an electrocatalyst adapted for use in a fuel cell, a charge transport element and/or charge generation element adapted for use in a solar cell, a photoconductor, a transistor, a biosensor, a glucose meter, and/or an alcohol detector, etc. The hybrid composite can comprise tubular carbon and graphene produced via pyrolysis of a milled solid carbon source under an unoxidizing environment. When analyzed via X-ray diffraction, the hybrid composite can generate peaks at two theta values of approximately 26.5 degrees, approximately 42.5 degrees, and approximately 54.5 degrees.

### Definitions

When the following terms are used substantively herein, the accompanying definitions apply. These terms and definitions are presented consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapted to—made suitable or fit for a specific use or situation.
adsorb—to adhere to a surface.
alcohol detector—a device and/or system adapted to identify, qualitatively and/or quantitatively, the presence of an organic compound comprising a hydroxyl functional group (—OH) that is bound to a carbon atom.
and/or—either in conjunction with or in alternative to.
apparatus—an appliance or device for a particular purpose.
battery—one or more electrochemical cells adapted to convert stored chemical energy into electrical energy.
battery electrode—an electrical conductor used to make contact with a nonmetallic part of an electrochemical cell, wherein the electrochemical cell is adapted to convert chemical energy to electrical energy.
biosensor—an analytical device for the detection of an analyte that combines a biological component with a physicochemical detector component.
bipolar plate—conductive plate in a fuel cell stack that acts as an anode for one cell and a cathode for an adjacent cell. The plate can comprise a metal or a conductive polymer (which can be a carbon-filled composite).
blend—to mix together.
can—is capable of, in at least some embodiments.
carbon nanofiber—a substantially cylindrical nanostructure with graphene layers arranged as stacked cones, cups, or plates.
carbon nanorod—a nanocrystalline form of diamond.
carbon nanotube—a Carbon nanofiber comprising graphene layers wrapped into substantially perfect cylinders.
carbon nanowires—a nanostructure comprising carbon and having a diameter of approximately a nanometer (10⁻⁹ meters) and in which electrons are quantum confined laterally.
ceramic—an inorganic, nonmetallic solid.
charge generation element—a substance adapted to, responsive to incident light, induce a charge separation of electron-hole pairs across various layers of a multiple layer device.
charge transport element—a substance adapted to conduct holes from a charge generating substance to a charge receiving substance.
comprising—including but not limited to.
conduct—to transmit electrical energy.
conductive—adapted to transmit electrical energy.
device—a machine, manufacture, and/or collection thereof.
electrocatalyst—a material adapted to increase the rate of a chemical reaction at an electrode surface without being consumed by the chemical reaction.
electromagnetic shielding—a barrier, made of conductive and/or magnetic materials, adapted to reduce an electromagnetic field in a space by blocking the field.
flake—a substantially planar lattice of carbon atoms.
fuel cell—a system adapted to convert chemical energy from a fuel into electricity through a chemical reaction with oxygen or another oxidizing agent.
full adsorption—a state when free radicals generated from solid carbon sources under a thermal decomposition reaction (pyrolysis) substantially completely adsorb onto the surface of a catalyst molecule and grow into a tube shape.
generate—to produce.
glucose meter—a device and/or system adapted for determining an approximate concentration of glucose in blood.
graphene—an allotrope of carbon having a structure of approximately one-atom-thick planar sheets of sp2-bonded carbon atoms in a honeycomb crystal lattice.
hybrid composite—a material comprising two constituents at the nanometer or molecular level.
ink—a liquid or paste that contains pigments and/or dyes adapted to produce electrically conductive patterns when used in a suitable system.
iron relative—a compound comprising at least one of iron inorganic salts, iron organic salts, iron chelates, iron organo metallic compounds.
lacquer—a varnish that dries by solvent evaporation and/or a curing process to produce a relatively durable finish.
light emitting diode—a semi-conductor adapted to produce light by a solid state process called electroluminescence.
may—is allowed and/or permitted to, in at least some embodiments.
method—a process, procedure, and/or collection of related activities for accomplishing something.
nano-platelets—nanoparticles comprising stacks of graphene that are 1 to 15 nanometers thick, with diameters ranging from sub-micrometer to 100 micrometers.
nitrile—a compound of nitrogen where nitrogen has a formal oxidation state of −3.
obtain—to come into possession of, get, acquire, and/or procure.
oven—a chamber used adapted for heating a substance.
oxide—a chemical compound that contains at least one oxygen atom in its chemical formula.
photoconductor—a material whose resistance changes with increasing incident light intensity.
photo resistor—a material whose resistance decreases with increasing incident light intensity.
plasma chemical vapor deposition—a process adapted to deposit relatively thin films from a gas state to a solid state on a substrate. Chemical reactions are involved in the process, which occur after creation of a plasma of the reacting gases.
polymer—a macromolecule comprising repeating structural subunits that are typically connected by covalent chemical bonds.
present—being in a specified thing.
printed electronics—components produced via a method wherein electrically functional electronic or optical inks are deposited on the substrate, to create active or passive devices, such as thin film transistors or resistors.
produce—to make or manufacture.
provide—to furnish, supply, give, and/or make available.
pyrolyze—to thermochemically decompose an organic material at a temperature above approximately 200 degrees Celsius in the substantial absence of oxygen.
pyrolysis—a thermochemical decomposition of organic material at a temperature above approximately 200 degrees Celsius in the substantial absence of oxygen.
salt—any of a class of compounds formed by the replacement of one or more hydrogen atoms of an acid with elements or groups, which are composed of anions and cations.
salt mill—to reduce a particle size of a solid via attrition via a medium comprising a salt.
semi-conducting—having a conductivity roughly in the range of 10³ to 10⁻⁸ siemens per centimeter.
solar cell—a solid state electrical device adapted to convert light energy directly into electricity via the photovoltaic effect.
solid carbon source—an organic substance that is in a physical state in which it resists changes in size and shape.
solvent—a substance adapted to dissolves another solid, liquid, or gaseous solute.
substantially—to a great extent or degree.
system—a collection of mechanisms, devices, machines, articles of manufacture, processes, data, and/or instructions, the collection designed to perform one or more specific functions.
thermal chemical vapor deposition—a process in which a substrate is exposed to one or more heated volatile precursors, which react and/or decompose on the substrate surface to produce a deposit.
transistor—a semiconductor device comprising at least three terminals and adapted to amplify and/or switch electronic signals and power.
transparent conductor—a substance that is substantially optically transparent and electrically conductive.
tubular—having a substantially cylindrical shape.
two theta values—detected intensities of an X-ray beam at a given detector swing angle (the detector swing angle of an X-ray diffraction system is defined as “two theta”).
unoxidizing environment—an atmosphere substantially devoid of reactive oxygen.
via—by way of and/or utilizing.
X-ray diffraction—a substantially non-destructive analytical technique adapted to determine information about crystallographic structure, chemical composition, and/or physical properties of materials based on detecting reflected intensities of X-ray beans at predetermined angels of incidence (theta).

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising a plurality of activities, comprising:
producing a system comprising a hybrid composite, said hybrid composite comprising tubular carbon and graphene, graphene flake, and graphene nano platelets, said hybrid composite present in at least one of:
conductive paint;
conductive lacquer;
electromagnetic shielding;
conductive ink adapted for use in printed electronics;
a conductor or transparent conductor adapted for use in a light emitting diode or in a laser diode;
a conductor or transparent conductor adapted for use in a solar cell;
an electrical conductor adapted for use in a battery electrode;
an electrical conductor;
a bipolar plate adapted for use in a fuel cell;
an electrocatalyst adapted for use in a fuel cell;
a charge transport or a charge generation element adapted for use in a solar cell;
a photoconductor;
a transistor;
a biosensor;
a glucose meter; or
an alcohol detector;
said hybrid composite produced via a specific catalyst comprised of at least one component comprising iron or a combination of a first component comprising iron with a second component that comprises a non-iron metal, said hybrid composite produced via pyrolysis of a milled solid carbon source under an unoxidizing environment, when analyzed via X-ray diffraction, said hybrid composite generating peaks at two theta values of approximately 26.5 degrees, approximately 42.5 degrees, and approximately 54.5 degrees.

2. The method of claim 1, further comprising:
obtaining said solid carbon source.

3. The method of claim 1, further comprising:
pyrolyzing said solid carbon source in an oven.

4. The method of claim 1, further comprising:
pyrolyzing said solid carbon source via plasma chemical vapor deposition.

5. The method of claim 1, further comprising:
pyrolyzing said solid carbon source via thermal chemical vapor deposition.

6. The method of claim 1, further comprising:
blending said hybrid composite with a solvent.

7. The method of claim 1, further comprising:
blending said hybrid composite with a metal.

8. The method of claim 1, further comprising:
blending said hybrid composite with a ceramic.

9. The method of claim 1, further comprising:
blending said hybrid composite with a polymer.

10. The method of claim 1, further comprising:
blending said hybrid composite with an oxide.

11. The method of claim 1, further comprising:
blending said hybrid composite with a nitrile.

12. The method of claim 1, further comprising:
blending said hybrid composite with a material comprising carbon.

13. The method of claim 1, wherein said tubular carbon is a carbon nanotube.

14. The method of claim 1, wherein said tubular carbon is between 0.01% and 99% of said hybrid composite.

15. The method of claim 1, wherein said graphene, graphene flake, and graphene nano platelets when analyzed via X-ray diffraction, generates peaks at two theta values of approximately 26.5 degrees.

16. The method of claim 1, wherein said graphene, graphene flake, graphene nano platelets when analyzed via X-ray diffraction, generates peaks at two theta values of approximately 26.5 degrees and approximately 54.5 degrees.

17. The method of claim 1, wherein said tubular carbon, when analyzed via X-ray diffraction, generates peaks at two theta values of approximately 44.5 degrees and approximately 51.6 degrees.

18. The method of claim 1, wherein said tubular carbon, when analyzed via X-ray diffraction, generates peaks at two theta values of approximately 26.5 degrees, 44.5 degrees, and approximately 51.6 degrees.

19. A system comprising:
a device comprising a hybrid composite, said hybrid composite present in at least one of:
conductive paint;
conductive lacquer;
electromagnetic shielding;
conductive ink adapted for use in printed electronics;
a conductor or transparent conductor adapted for use in a light emitting diode or in a laser diode;
a conductor or transparent conductor adapted for use in a solar cell;
an electrical conductor adapted for use in a battery electrode;
an electrical conductor;
a bipolar plate adapted for use in a fuel cell;
an electrocatalyst adapted for use in a fuel cell;
a charge transport or a charge generation element adapted for use in a solar cell;
a photoconductor;
a transistor;
a biosensor;
a glucose meter; or
an alcohol detector;
said hybrid composite comprising tubular carbon and graphene produced via pyrolysis of a milled solid carbon source under an unoxidizing environment, when analyzed via X-ray diffraction, said hybrid composite generating peaks at two theta values of approximately 26.5 degrees, approximately 42.5 degrees, and approximately 54.5 degrees.

20. A method comprising a plurality of activities, comprising:
producing a catalyst comprising iron, said catalyst arranged in a molecule that will not fully adsorb carbon free radicals, said catalyst adapted to, when present with a milled solid carbon source in pyrolysis in an unoxidizing environment, produce a hybrid composite comprising tubular carbon and graphene, when analyzed via X-ray diffraction, said hybrid composite generating peaks at two theta values of approximately 26.5 degrees, approximately 42.5 degrees, and approximately 54.5 degrees, said hybrid composite adapted for use in at least one of:
conductive paint;
conductive lacquer;
electromagnetic shielding;
conductive ink adapted for use in printed electronics;
a conductor or transparent conductor adapted for use in a light emitting diode or in a laser diode;
a conductor or transparent conductor adapted for use in a solar cell;
an electrical conductor adapted for use in a battery electrode;
an electrical conductor;
a bipolar plate adapted for use in a fuel cell;
an electrocatalyst adapted for use in a fuel cell;
a charge transport or a charge generation element adapted for use in a solar cell;
a photoconductor;
a transistor;
a biosensor;
a glucose meter; or
an alcohol detector.
